(19) United States
(12) Patent Application Publication
(10) Pub. No.: US 2011/0035227 A1
(43) Pub. Date: Feb. 10, 2011

(54) METHOD AND APPARATUS FOR ENCODING/DECODING AN AUDIO SIGNAL BY USING AUDIO SEMANTIC INFORMATION

(75) Inventors: Sang-Hoon Lee, Seoul (KR); Chul-Woo Lee, Anyang-si (KR); Jong-Hoon Jeong, Suwon-si (KR); Nam-Suk Lee, Suwon-si (KR); Han-Gil Moon, Seoul (KR); Hyun-Wook Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/988,382

(22) PCT Filed: Apr. 16, 2009
(86) PCT No.: PCT/KR09/01989

§ 371 Date: Oct. 18, 2010

Related U.S. Application Data
(60) Provisional application No. 61/071,213, filed on Apr. 17, 2008.

(30) Foreign Application Priority Data
Apr. 15, 2009 (KR) 10-2009-0032758

(51) Int. Cl. G10L 19/00

(52) U.S. Cl. 704/500; 704/E19.001

(57) ABSTRACT

An audio signal encoding method and apparatus and an audio signal decoding method and apparatus are provided. The audio signal encoding method includes: transforming an audio signal into a signal of a frequency domain; extracting semantic information from the audio signal; variably reconfiguring one or more sub-bands included in the audio signal by segmenting or grouping the one or more sub-bands using the extracted semantic information; and generating a quantized bitstream by calculating a quantization step size and a scale factor with respect to a reconfigured sub-band of the one or more sub-bands.

### CROSS-REFERENCE TO RELATED PATENT APPLICATION

This application is a National Stage application under 35 U.S.C. §371 of PCT/KR2009/001989 filed on Apr. 16, 2009, which claims priority from U.S. Provisional Patent Application No. 61/071,213, filed on Apr. 17, 2008 in the U.S. Patent and Trademark Office, and Korean Patent Application No. 10-2009-0032758, filed on Apr. 15, 2009 in the Korean Intellectual Property Office, all the disclosures of which are incorporated herein in their entireties by reference.

### BACKGROUND

1. Field

Apparatuses and methods consistent with exemplary embodiments relate to encoding and decoding audio signals by using audio semantic information, whereby quantization noise is minimized and an encoding efficiency is increased.

2. Description of the Related Art

In general data compression, a result before compression and a result after the compression are to be equivalent to each other. However, in a case of data such as audio or image signals which are dependent upon a perceiving ability of a human, it may be acceptable for a result after compression to only include data that can be perceived by the perceiving ability of human. Thus, a lossy compression technique is frequently used in encoding of audio signals.

In order to encode audio signals, quantization is performed in lossy compression. Here, the quantization refers to a procedure in which an actual value of an audio signal is divided in units of predetermined steps, and a representative value is applied to each of divided segments in order to indicate each of the divided segments,. That is, the quantization is a process of expressing a scale of a waveform of an audio signal by using quantization levels of a predetermined quantization step. For efficient quantization, a quantization step size is determined appropriately.

In particular, if the quantization step is too large, quantization noise occurring in the quantization increases such that the quality of an actual audio signal significantly deteriorates. Conversely, if the quantization step is too small, the quantization noise decreases but the number of audio signal segments to be expressed after the quantization increases such that a bit-rate for encoding increases.

Accordingly, for high quality and high efficient encoding, a quantization step sufficient to prevent audio signal deterioration due to the quantization noise and to decrease the bit-rate is desired.

Many audio codecs, including Moving Picture Experts Group-2/4 Advanced Audio Coding (MPEG-2/4 AAC), involve transforming an input signal of a time domain into a signal of a frequency domain by performing modified discrete cosine transformation (MDCT) and Fast Fourier transformation (FFT), and performing quantization by dividing the signal of the frequency domain into a plurality of sub-bands which are referred to as scale factor bands.

Here, the scale factor band uses a predetermined sub-band in consideration of a coding efficiency, and each of the sub-bands uses side information including a scale factor, a Huffman code index, and the like with respect to a corresponding sub-band.

In the quantization procedure, in order to form quantization noise in a range allowed by psychoacoustic models for MPEG audio, a quantization step size and a scale factor with respect to each of the sub-bands are optimized to an allowed bit-rate by using two repetitive loops (that is, an inner iteration loop and an outer iteration loop). Here, setting with respect to the sub-bands is a relevant factor to minimize the quantization noise and to increase a coding efficiency.

### SUMMARY

One or more exemplary embodiments provide a method and apparatus for encoding and decoding audio signals by using audio semantic information.

According to an aspect of an exemplary embodiment, there is provided an audio signal encoding method including: transforming an audio signal into a signal of a frequency domain; extracting semantic information from the audio signal; variably reconfiguring one or more sub-bands by segmenting or grouping the one or more sub-bands included in the audio signal by using the extracted semantic information; and generating a quantized first bitstream by calculating a quantization step size and a scale factor with respect to a reconfigured sub-band of the one or more sub-bands.

The semantic information may be defined in units of frames of the audio signal, and may indicate a statistical value with respect to a plurality of coefficient amplitudes included in one or more sub-bands of each of the frames.

The semantic information may include an audio semantic descriptor that is metadata used in searching or categorizing music of the audio signal.

The extracting the semantic information may include calculating spectral flatness of a first sub-band from among the one or more sub-bands.

If the spectral flatness is less than a predetermined threshold value, the extracting the semantic information may further include calculating a spectral sub-band peak value of the first sub-band, and the reconfiguring the one or more sub-bands may include segmenting the first sub-band into a plurality of sub-bands according to the spectral sub-band peak value.

If the spectral flatness is greater than a predetermined threshold value, the extracting the semantic information may further include calculating a spectrum flux value indicating variation of energy distributions between the first sub-band and a second sub-band adjacent to the first sub-band, and if the spectrum flux value is less than a predetermined threshold value, the reconfiguring the one or more sub-bands may further include grouping the first sub-band and the second sub-band.

The audio signal encoding method may further include: generating a second bitstream including at least one of the spectral flatness, the spectral sub-band peak value, and the spectral flux value; and transmitting the second bitstream together with the first bitstream.

According to an aspect of another exemplary embodiment, there is provided an audio signal decoding method including: receiving a first bitstream of an encoded audio signal and a second bitstream indicating semantic information of the audio signal; determining at least one sub-band of the audio signal that is variably configured in the first bitstream, by using the second bitstream of the semantic information; and calculating an inverse-quantization step size and a scale factor with respect to the at least one sub-band, and inverse-quantizing the first bitstream.

The semantic information may be defined in units of frames of the encoded audio signal, and may indicate a statistical value with respect to a plurality of coefficient amplitudes included in one or more sub-bands of each of the frames.

The semantic information may include at least one of spectral flatness, a spectral sub-band peak value, and a spectral flux value with respect to the one or more sub-bands.

According to an aspect of another exemplary embodiment, there is provided an audio signal encoding apparatus including: a transform unit which transforms an audio signal into a signal of a frequency domain; a semantic information generation unit which extracts semantic information from the audio signal; a sub-band reconfiguration unit which variably reconfigures one or more sub-bands of the audio signal by segmenting or grouping the one or more sub-bands using the extracted semantic information; and a first encoding unit which generates a quantized first bitstream by calculating a quantization step size and a scale factor with respect to a reconfigured sub-band.

The semantic information may be defined in units of frames of the audio signal, and may indicate a statistical value with respect to a plurality of coefficient amplitudes included in one or more sub-bands of each of the frames.

The semantic information may include an audio semantic descriptor that is metadata used in searching or categorizing music of the audio signal.

The semantic information generation unit may further include a flatness generation unit which calculates spectral flatness of a first sub-band from among the one or more sub-bands.

If the spectral flatness is less than a predetermined threshold value, the semantic information generation unit may further include a sub-band peak value calculation unit which calculates a spectral sub-band peak value of the first sub-band, and the sub-band reconfiguration unit may include a segmenting unit which segments the first sub-band into a plurality of sub-bands according to the spectral sub-band peak value.

If the spectral flatness is greater than a predetermined threshold value, the semantic information generation unit may further include a flux value calculation unit which calculates a spectrum flux value indicating variation of energy distributions between the first sub-band and a second sub-band adjacent to the first sub-band, and if the spectrum flux value is less than a predetermined threshold value, the sub-band reconfiguration unit may include a grouping unit which groups the first sub-band and the second sub-band.

The audio signal encoding apparatus may further include a second encoding unit which generates a second bitstream including at least one of the spectral flatness, the spectral sub-band peak value, and the spectral flux value, wherein the second bitstream may be transmitted together with the first bitstream.

According to an aspect of another exemplary embodiment, there is provided an audio signal decoding apparatus including: a receiving unit which receives a first bitstream of an encoded audio signal and a second bitstream indicating semantic information of the audio signal; a sub-band determining unit which determines at least one sub-band of the audio signal that is variably configured in the first bitstream, by using the second bitstream of the semantic information; and a decoding unit which calculates an inverse-quantization step size and a scale factor with respect to the at least one sub-band, and inverse-quantizes the first bitstream.

The semantic information may be defined in units of frames of the encoded audio signal, and may indicate a statistical value with respect to a plurality of coefficient amplitudes included in one or more sub-bands of each of the frames.

The semantic information may include at least one of spectral flatness, a spectral sub-band peak value, and a spectral flux value with respect to the one or more sub-bands.

According to an aspect of another exemplary embodiment, there is provided an audio signal decoding method including: determining at least one sub-band of an audio signal that is variably configured in a bitstream of the audio signal, by using semantic information of the audio signal transmitted with the audio signal; and calculating an inverse-quantization step size and a scale factor with respect to the at least one sub-band, and inverse-quantizing the first bitstream based on the calculated inverse-quantization step size and the calculated scale factor.

According to one or more exemplary embodiments, when an audio signal is encoded, a pre-fixed sub-band according to the related art is not used, but an audio semantic descriptor from among metadata may be used in managing and searching multimedia data is applied to a procedure of reconfiguration of one or more sub-bands. Accordingly, the one or more sub-bands may be variably segmented and grouped, so that quantization noise may be minimized and a coding efficiency may be increased.

In addition to compression of the audio signal, pre-extracted audio semantic descriptor information may also be used in applications involving categorizing and searching music according to one or more exemplary embodiments. Thus, according to one or more exemplary embodiments, it is not necessary to separately transmit metadata so as to transmit the audio semantic descriptor information. Rather, semantic information used in the compression of the audio signal may be used in a reception terminal, so that the number of bits for transmission of the metadata may be reduced.

### BRIEF DESCRIPTION OF THE DRAWINGS

FIG. 1 is a table indicating predetermined scale factor bands that are used in an audio signal encoding procedure;

FIG. 2 is a graph for explanation of signal-to-noise ratio (SNR), signal-to-mask ratio (SMR), and noise-to-mask ratio (NMR) with respect to a masking effect;

FIG. 3 is a flowchart of an audio signal encoding method according to an exemplary embodiment;

FIG. 4 illustrates a method of segmenting a sub-band according to an exemplary embodiment;

FIG. 5 illustrates a method of grouping sub-bands according to an exemplary embodiment;

FIG. 6 is a flowchart for describing in detail an audio signal encoding method according to an exemplary embodiment;

FIG. 7 is a block diagram of an audio signal encoding apparatus according to an exemplary embodiment; and

FIG. 8 is a block diagram of an audio signal decoding apparatus according to an exemplary embodiment.

### DETAILED DESCRIPTION OF EXEMPLARY EMBODIMENTS

The attached drawings for illustrating exemplary embodiments are referred to in order to gain an understanding of the exemplary embodiments, the merits thereof, and the objectives accomplished by the implementation of the exemplary embodiments.

Hereinafter, the exemplary embodiments will be described in detail with reference to the attached drawings. It is understood that hereinafter, expressions such as “at least one of,” when preceding a list of elements, modify the entire list of elements and do not modify the individual elements of the list.

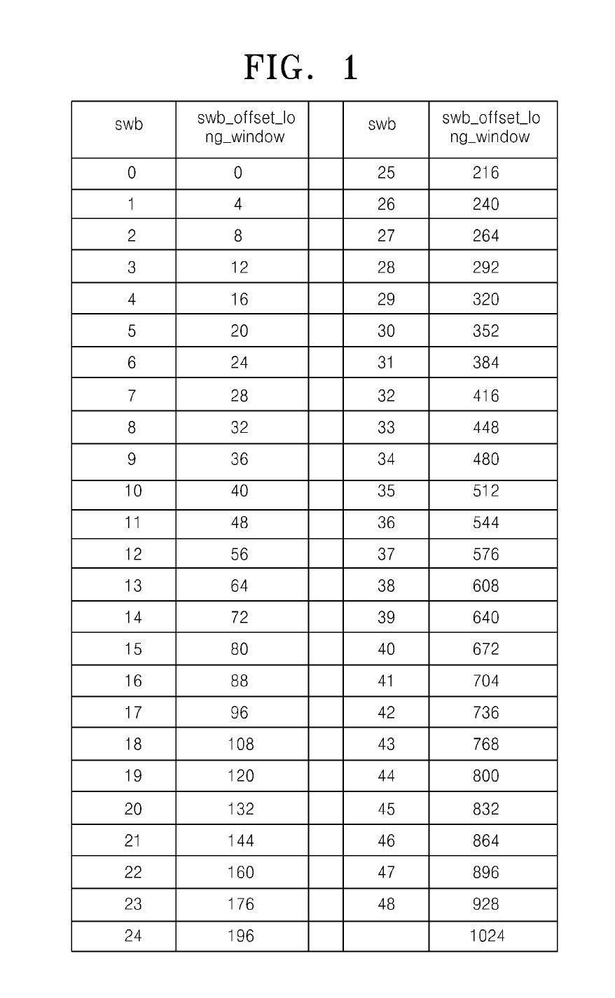

FIG. 1 is a table indicating predetermined scale factor bands that are used in an audio signal encoding procedure, and is an example of scale factor bands that are used in sub-band encoding by Moving Picture Experts Group-2/4 Advanced Audio Coding (MPEG-2/4 AAC).

The sub-band encoding indicates a process in which a frequency component of a signal is divided in units of bandwidths so as to efficiently use psychoacoustics of a critical band (CB). In the sub-band encoding, original signals that are input according to a temporally sequential order are not encoded, but each of a plurality of sub-bands in a frequency domain is encoded.

Here, a predetermined scale factor band table is used. Referring to the exemplary table of FIG. 1, a scale factor and a quantization step size with respect to each of sub-bands is optimized by using predetermined 49 fixed bands (frequency intervals of bands indicate relatively smaller intervals in a low frequency). In a quantization procedure, in order to form quantization noise in a range allowed by psychoacoustic models for MPEG audio, the quantization step size and the scale factor are optimized by using two repetitive loops (that is, an inner iteration loop and an outer iteration loop).

However, when a scale factor is determined so as to allow a maximum amplitude of a plurality of pieces of sample data in one sub-band to be 1.0, if the sub-band includes a significantly large coefficient compared to other coefficient amplitudes in the sub-band, a relatively large quantization step size is applied so as to form quantization noise that is acceptable in an allowed bit-rate, such that noise increases in a sample having a small amplitude. This phenomenon will be described below with reference to a masking effect of the psychoacoustic models.

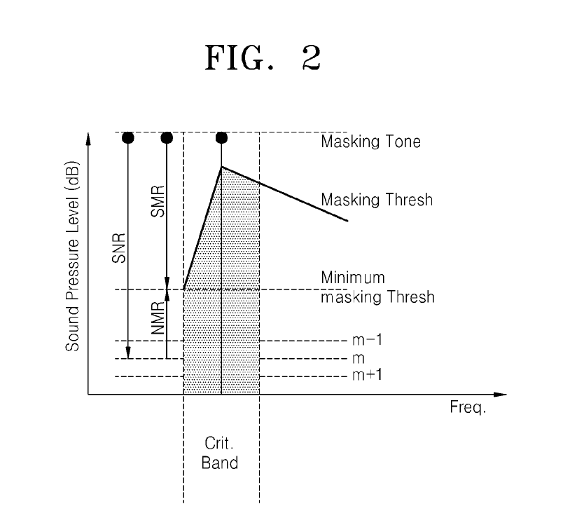

FIG. 2 is a graph for explanation of signal-to-noise ratio (SNR), signal-to-mask ratio (SMR), and noise-to-mask ratio (NMR) with respect to a masking effect.

According to psychoacoustic models for MPEG audio, in consideration of human auditory senses, a compression rate is increased by removing parts that are not perceptible to a human. This method is referred to as perceptual coding.

A representative fact related to the human auditory senses that are used in the perceptual coding is a masking effect. In brief, the masking effect indicates a phenomenon by which a small sound is masked by a big sound so that the small sound becomes non-perceptible when the small sound and the big sound simultaneously occur. In the present disclosure, the big sound, i.e., a masking sound, is referred to a masker, and the small sound masked by the masker is referred to as a maskee. The masking effect increases as a difference between a volume of the masker and a volume of the maskee increases. Additionally, the masking effect increases as a frequency of the masker becomes similar to that of the maskee. Also, although the small sound and the big sound do not occur at a temporally simultaneous time, the small sound occurring after the big sound may be masked.

Referring to FIG. 2, the graph shows a masking curve when there is a masking tone that performs masking. This masking curve is referred to as a spread function, and a sound below a masking threshold is masked by the masking tone. The masking effect uniformly occurs in a critical band.

Here, the SNR is defined as the ratio of a signal power to a noise power, and is a sound pressure level (dB) at which the signal power exceeds the noise power. An audio signal may be accompanied by noise, and the SNR is used to indicate a level of the audio signal to a level of the noise.

The SMR is used to indicate a relatively large level of a signal power to a level of a masking threshold. The masking threshold is determined based on a minimum masking threshold in a threshold band.

The NMR indicates a margin between the SMR and the SNR.

For example, as illustrated in FIG. 2, if the number of bits allocated to indicate an audio signal is m, the SNR, the SMR, and the NMR have relationships shown as arrows.

Here, when a quantization step size is set to be small, the number of bits used to encode the audio signal increases. For example, in the table of FIG. 1, if the number of bits is increased to m+1, the SNR increases accordingly. Conversely, if the number of bits is decreased to m−1, the SNR decreases accordingly. If the number of bits is decreased in such a manner that the SNR becomes less than the SMR, the NMR becomes greater than the masking threshold, such that quantization noise is not masked but exists and is perceptible to a human.

That is, in a case where the SNR is greater than the SMR in a certain bit-rate, fewer bits may be allocated to remove the quantization noise. However, in a case where the SNR is less than the SMR, a greater number of bits are allocated so as to remove the quantization noise.

Thus, in the quantization procedure, appropriate bits are allocated by adjusting the quantization step size and the scale factor so as to allow the quantization noise to be set below the masking curve of the psychoacoustic models for MPEG audio.

However, if a pre-fixed sub-band includes significantly large coefficients compared to other coefficient amplitudes in the sub-band, a relatively large quantization step size is applied. This relatively large quantization step becomes a factor that causes quantization noise in other samples having relatively small amplitudes.

Thus, a variable sub-band varying according to a coefficient amplitude is used instead of a pre-fixed sub-band. In order to generate the variable sub-band, an encoding method that involves using segmentation and grouping according to an exemplary embodiment will now be described.

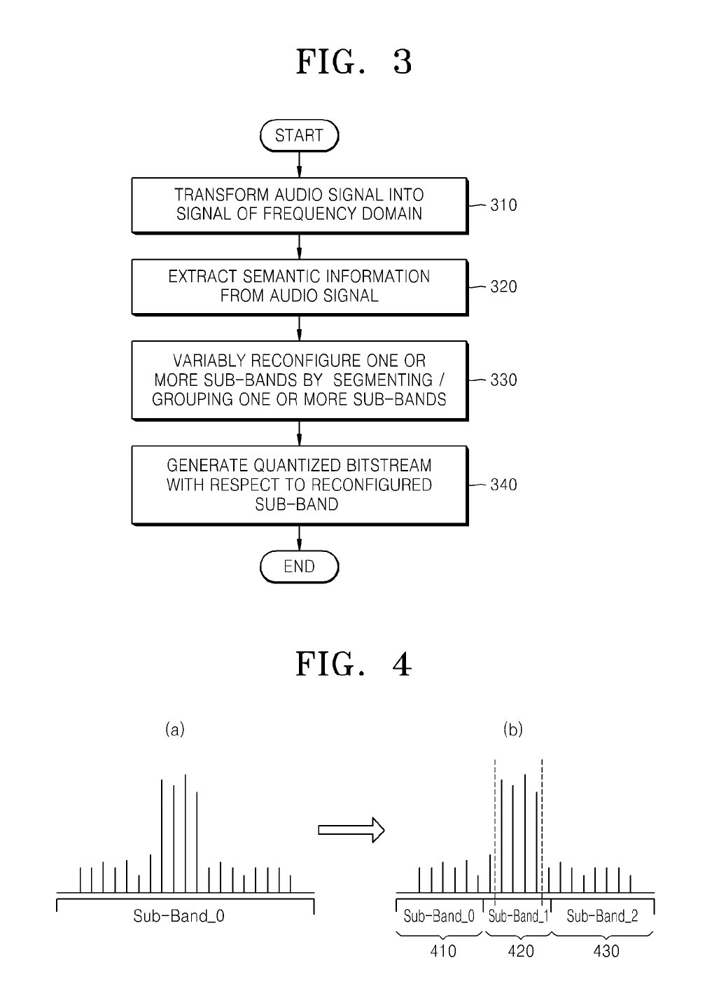

FIG. 3 is a flowchart of an audio signal encoding method according to an exemplary embodiment.

One or more exemplary embodiments provide a method of extracting an audio semantic descriptor from an audio signal, and variably reconfiguring sub-bands according to features of the audio signal by using the audio semantic descriptor, whereby quantization noise may be minimized and a coding efficiency may be improved.

Referring to FIG. 3, the audio signal encoding method includes transforming an audio signal into a signal of a frequency domain (operation 310), extracting semantic information from the audio signal (operation 320), variably reconfiguring one or more sub-bands by segmenting or grouping the one or more sub-bands, which are included in the audio signal, by using the extracted semantic information (operation 330), and generating a quantized bitstream by calculating a quantization step size and a scale factor with respect to a reconfigured sub-band (operation 340).

In operation 310, the input audio signal of a time domain is transformed into the signal of the frequency domain. Audio codecs such as MPEG-2/4 AAC may transform the input audio signal of the time domain into the signal of the frequency domain by performing modified discrete cosine transformation (MDCT) or Fast Fourier transformation (FFT).

In operation 320, the semantic information is extracted from the audio signal. As an example, MPEG-7 focuses on a search operation of multimedia information, and supports various features indicating multimedia data, such as lower abstraction level description about a form, a size, a texture, a color, movement, and position, and higher abstraction level description about semantic information.

The semantic information is defined in units of frames of the audio signal of the frequency domain, and indicates a statistical value with respect to a plurality of coefficient amplitudes included in one or more sub-bands of a frame.

In an audio searching operation, timbre, tempo, rhythm, mood, tone, and the like may be relevant features. In this case, metadata related to a timbre feature includes spectral centroid, a bandwidth, roll-off, spectral flux, a spectral sub-band peak, a sub-band valley, sub-band average, and the like.

According to the present exemplary embodiment, spectral flatness and a spectral sub-band peak value are used with respect to the segmentation, and spectral flatness and a spectral flux value are used with respect to the grouping.

In operation 330, the one or more sub-bands included in the audio signal are variably reconfigured in a manner that the one or more sub-bands are segmented or grouped by using the extracted semantic information.

In an audio codec, every frame may be divided into predetermined sub-bands, and each of the sub-bands may be allocated a scale factor and a Huffman code index as side information. When variation of coefficient amplitudes between adjacent sub-bands is small (i.e., flatness), a coding efficiency may be improved by grouping a plurality of similar sub-bands and then applying one side information to the group, compared to a case in which a scale factor and a Huffman code index are applied to each of sub-bands. Thus, the one or more sub-bands may be grouped and reconfigured into a new sub-band.

Also, as described above, if a sub-band includes a significantly large coefficient compared to other coefficient amplitudes in the sub-band, a relatively large quantization step size is to be applied, such that noise increases in a sample having a small amplitude. Thus, a sub-band is segmented into a plurality of sub-bands so that spectral flatness may be uniformly maintained in each of the sub-bands. Accordingly, it is possible to prevent occurrence of quantization noise.

In operation 340, the quantized bitstream is generated by calculating the quantization step size and the scale factor with respect to the reconfigured sub-band. That is, quantization is not performed on a fixed sub-band according to a predetermined scale factor band table, but is performed on the variably reconfigured sub-band. In the quantization procedure, in order to form quantization noise in a range allowed by the psychoacoustic models for MPEG audio, a bit-rate control is performed in an inner iteration loop and a distortion control is performed in an outer iteration loop. By doing so, the quantization step size and the scale factor are optimized, and noiseless coding is performed.

Hereinafter, a sub-band reconfiguration procedure via segmentation or grouping will be described in detail.

FIG. 4 illustrates a method of segmenting a sub-band according to another exemplary embodiment.

As illustrated in FIG. 4(a), spectral flatness of one sub-band (sub-band_0) is obtained.

The spectral flatness may be calculated by using Equation 1:

$$Flatness = \frac{\sqrt[N]{{\prod }_{n = 0}^{N - 1} x ( n )}}{( \frac{{\sum }_{n = 0}^{N - 1} x ( n )}{N} )} , \qquad [ Equation 1 ]$$

where N is a total of the number of samples in the sub-band.

A value of the spectral flatness being large may indicate that samples in a corresponding sub-band have similar energy levels, and the value of the spectral flatness being small may indicate that a spectrum energy is relatively concentrated on a specific position.

The calculated spectral flatness is compared with a predetermined threshold value. The predetermined threshold value is a predetermined test value in consideration of a sub-band segmentation efficiency.

According to the comparison, the spectral flatness being greater than the threshold value indicates that variation between amplitudes of the samples is small and an energy is uniformly dispersed in the sub-band, so that it is not necessary to perform the segmentation on the sub-band.

However, the spectral flatness being less than the threshold value indicates that the spectrum energy in the sub-band is relatively concentrated on a specific position. In this case, a quantization step size increases and noise occurs such that the noise may be perceptible to a human. Accordingly, the sub-band is to be segmented into separate sub-bands. As illustrated in exemplary FIG. 4(a), amplitudes of samples in the sub-band are not flat, so that the sub-band is to be segmented, as illustrated in FIG. 4(b).

For example, by calculating a spectral sub-band peak value of the sub-band by using Equation 2 below, the sub-band is segmented with respect to the specific position where the spectrum energy is concentrated.

$${B}_{peak} ( n ) = {max}_{0 \leq i \leq l - 1} [ \vert {S}_{i} ( n ) \vert ] . \qquad [ Equation 2 ]$$

As a result of the segmentation on the sub-band (sub-band_0) of FIG. 4(a), the sub-band (sub-band_0) is reconfigured into three sub-bands (sub-band_0 (410), sub-band_1 (420), and sub-band_2 (430)) of FIG. 4(b). That is, a band where the spectrum energy is concentrated is segmented into the sub-band_1 (420). By doing so, it is possible to determine an optimized quantization step size with respect to each of the three sub-bands. Moreover, quantization and encoding are performed on each of the three sub-bands.

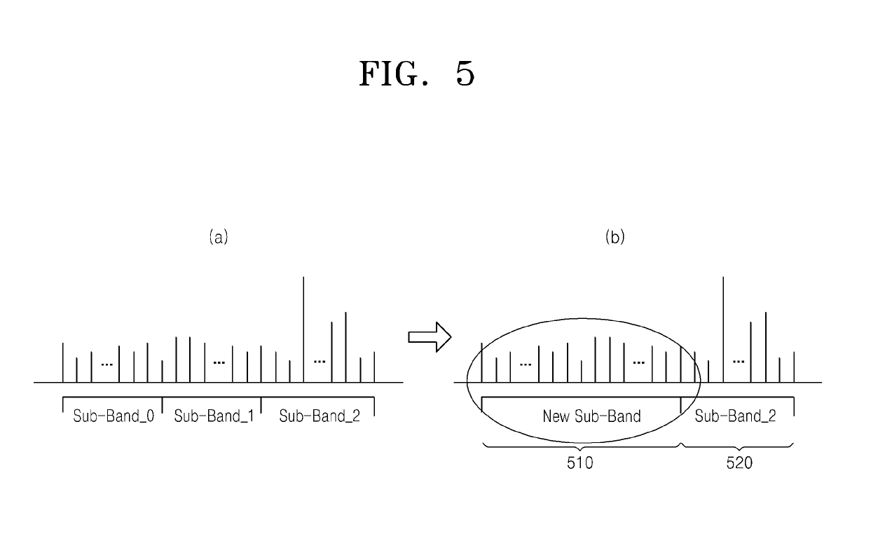

FIG. 5 illustrates a method of grouping sub-bands according to an exemplary embodiment.

In a similar manner to the method of segmenting a sub-band, spectral flatness of each of sub-bands is obtained in FIG. 5(a). A value of the spectral flatness being large may indicate that samples in a corresponding sub-band have similar energy levels.

The calculated spectral flatness is compared with a predetermined threshold value. The spectral flatness being greater than the threshold value indicates that variation between amplitudes of the samples is small, and an energy is uniformly dispersed in the sub-band. Thus, a spectrum flux value with respect to an adjacent sub-band may be obtained as provided in Equation 3:

$$F ( n ) = {\sum }_{i = 0}^{k - 1} {( {S}_{i} ( n ) - {S}_{i} ( n - 1 ) )}^{2} \qquad [ Equation 3 ]$$

The spectrum flux value indicates variation of energy distributions in two sequential frequency bands. If the spectrum flux value is less than a predetermined threshold value, adjacent sub-bands may be grouped into one sub-band.

Referring to FIG. 5, from among sub-band_0, sub-band_1, and sub-band_2 of FIG. 5(a), sub-band_0 and sub-band_1 having similar energy distributions may be grouped into one sub-band (new sub-band 510 of FIG. 5(b).

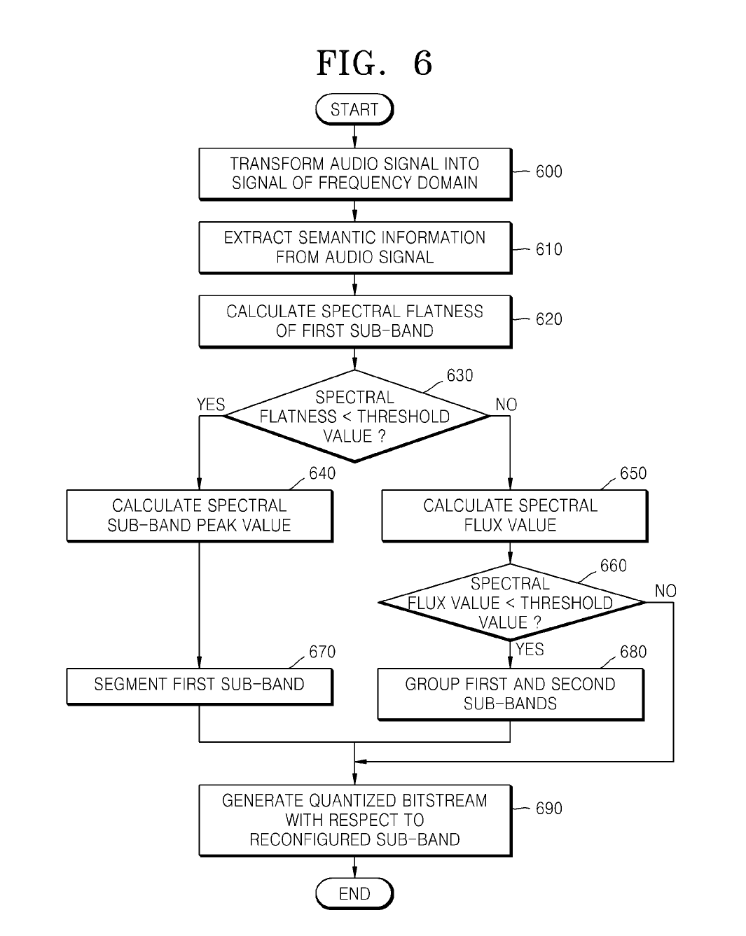

FIG. 6 is a flowchart for describing in detail an audio signal encoding method according to an exemplary embodiment.

According to the audio signal encoding method, an audio signal is transformed into a signal of a frequency domain (operation 600), and semantic information is extracted from the audio signal (operation 610). The semantic information may include an audio semantic descriptor that is metadata used in searching or categorizing music.

Spectral flatness of a first sub-band in the semantic information is calculated (operation 620), and the calculated spectral flatness is compared with a threshold value (operation 630).

According to the comparison, the spectral flatness being less than the threshold value indicates that a spectrum energy in the first sub-band is concentrated on a specific position, so that the first sub-band is to be segmented into a plurality of sub-bands. Thus, a spectral sub-band peak value of the first sub-band is calculated (operation 640), and the first sub-band is segmented with respect to the specific position where the spectrum energy is concentrated (operation 670).

According to the comparison between the spectral flatness and the threshold value (operation 630), the spectral flatness being greater than the threshold value indicates that variation between amplitudes of samples is small, and an energy is uniformly dispersed in the first sub-band. Thus, a spectrum flux value with respect to an adjacent second sub-band is obtained (operation 650).

If the spectrum flux value is less than a predetermined threshold value (operation 660), adjacent sub-bands (e.g., the first sub-band and the second sub-band) are grouped into one sub-band (operation 680).

Afterward, quantization and encoding are performed on each of the segmented or grouped sub-bands, so that a bitstream is generated (operation 690).

In addition, the spectral flatness, the spectral sub-band peak value, and the spectrum flux value are generated into a bitstream, and transmitted along with the bitstream of the audio signal to a decoder terminal.

A decoding process in a decoder terminal according to an exemplary embodiment includes receiving a first bitstream of the encoded audio signal and a second bitstream indicating the semantic information in the audio signal, determining a variable sub-band included in the first bitstream by using the second bitstream of the semantic information, calculating an inverse-quantization step size and a scale factor with respect to the determined sub-band, and inverse-quantizing and decoding the first bitstream.

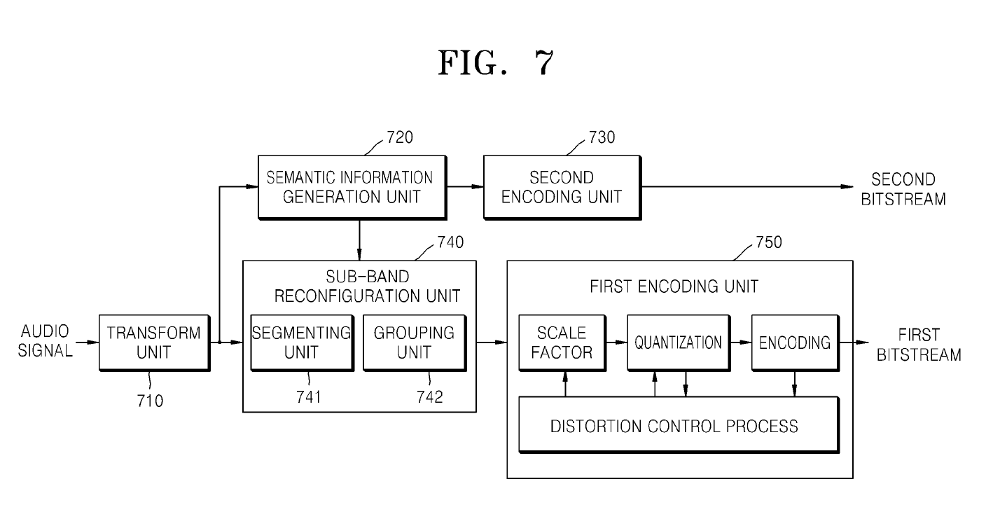

FIG. 7 is a block diagram of an audio signal encoding apparatus according to an exemplary embodiment.

Referring to FIG. 7, the audio signal encoding apparatus includes a transform unit 710 which transforms an audio signal into a signal of a frequency domain, a semantic information generation unit 720 which extracts semantic information from the audio signal, a sub-band reconfiguration unit 740 which variably reconfigures one or more sub-bands by segmenting or grouping the one or more sub-bands included in the audio signal by using the extracted semantic information, and a first encoding unit 750 which generates a quantized first bitstream by calculating a quantization step size and a scale factor with respect to a reconfigured sub-band.

The transform unit 710 transforms an input audio signal into a signal of the frequency domain by performing MDCT or FFT. The semantic information generation unit 720 defines an audio semantic descriptor in units of frames in the frequency domain. Here, the semantic information generation unit 720 may refer to a critical band (CB), which is provided by psychoacoustic models for MPEG audio, as a base sub-band, and extracts spectral flatness, a spectral sub-band peak value, and a spectral flux value with respect to each of a corresponding frame and the CB. The sub-band reconfiguration unit 740 may further include a segmenting unit 741 and a grouping unit 742, and may variably reconfigure sub-bands by segmenting or grouping the sub-bands by using a semantic descriptor extracted from each frame.

The first encoding unit 750 obtains a quantization step size and a scale factor for each sub-band, which are optimized to an allowed bit-rate, by performing a repetitive loop procedure. Furthermore, the first encoding unit 750 performs quantization and encoding.

In addition, the audio signal encoding apparatus may further include a second encoding unit 730 which generates a second bitstream including at least one of spectral flatness, a spectral sub-band peak value, and a spectral flux value. The generated second bitstream is transmitted together with the first bitstream.

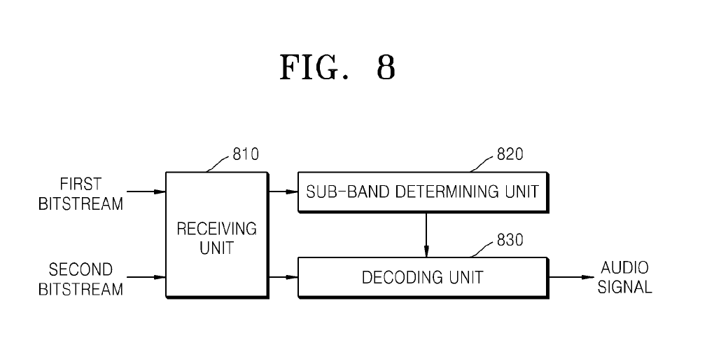

FIG. 8 is a block diagram of an audio signal decoding apparatus according to an exemplary embodiment.

Referring to FIG. 8, the audio signal decoding apparatus includes a receiving unit 810 which receives a first bitstream of an encoded audio signal and a second bitstream indicating semantic information of the encoded audio signal, a sub-band determining unit 820 which determines one or more variably reconfigured sub-bands in the first bitstream by using the second bitstream indicating the semantic information, and a decoding unit 830 which inverse-quantizes the first bitstream by calculating an inverse-quantization step size and a scale factor with respect to the determined sub-band.

While not restricted thereto, one or more exemplary embodiments can be written as computer programs and can be implemented in general-use digital computers that execute the programs using a computer readable recording medium. In addition, a data structure used in exemplary embodiments can be written in a computer readable recording medium through various means. Examples of the computer readable recording medium include magnetic storage media (e.g., ROM, floppy disks, hard disks, etc.), optical recording media (e.g., CD-ROMs, or DVDs), etc. Moreover, while not required in all exemplary embodiments, one or more units of the encoding and decoding apparatuses can include a processor or microprocessor executing a computer program stored in a computer-readable medium.

While exemplary embodiments have been particularly shown and described with reference to the drawings, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the inventive concept is defined not by the detailed description of the exemplary embodiments but by the appended claims, and all differences within the scope will be construed as being included in the present inventive concept.

1. An audio signal encoding method comprising:
transforming an audio signal into a signal of a frequency domain;
extracting semantic information from the audio signal;
variably reconfiguring one or more sub-bands comprised in the audio signal by segmenting or grouping the one or more sub-bands using the extracted semantic information; and
generating a quantized first bitstream by calculating a quantization step size and a scale factor with respect to a reconfigured sub-band of the one or more sub-bands.

2. The audio signal encoding method of claim 1, wherein the semantic information is defined in units of frames of the audio signal, and indicates a statistical value with respect to a plurality of coefficient amplitudes comprised in one or more sub-bands of each of the frames.

3. The audio signal encoding method of claim 2, wherein the semantic information comprises an audio semantic descriptor that is metadata used in searching or categorizing music of the audio signal.

4. The audio signal encoding method of claim 1, wherein the extracting the semantic information further comprises calculating spectral flatness of a first sub-band of the one or more sub-bands.

5. The audio signal encoding method of claim 4, wherein:
if the spectral flatness is less than a predetermined threshold value, the extracting the semantic information further comprises calculating a spectral sub-band peak value of the first sub-band; and
if the spectral flatness is less than the predetermined threshold value, the variably reconfiguring the one or more sub-bands further comprises segmenting the first sub-band into a plurality of sub-bands according to the spectral sub-band peak value.

6. The audio signal encoding method of claim 4, wherein:
if the spectral flatness is greater than a predetermined threshold value, the extracting the semantic information further comprises calculating a spectrum flux value indicating variation of energy distributions between the first sub-band and a second sub-band adjacent to the first sub-band; and
if the spectral flatness is greater than the predetermined threshold value and the spectrum flux value is less than a predetermined threshold value, the variably reconfiguring of the one or more sub-bands further comprises grouping the first sub-band and the second sub-band together.

7. The audio signal encoding method of claim 5, further comprising:
generating a second bitstream comprising at least one of the spectral flatness and the spectral sub-band peak value; and
transmitting the second bitstream with the first bitstream.

8. An audio signal decoding method comprising:
receiving a first bitstream of an encoded audio signal and a second bitstream indicating semantic information of the audio signal;
determining at least one sub-band of the audio signal that is variably configured in the first bitstream of the audio signal, by using the second bitstream indicating the semantic information; and
calculating an inverse-quantization step size and a scale factor with respect to the at least one sub-band, and inverse-quantizing the first bitstream based on the calculated inverse-quantization step size and the calculated scale factor.

9. The audio signal decoding method of claim 8, wherein the semantic information is defined in units of frames of the encoded audio signal, and indicates a statistical value with respect to a plurality of coefficient amplitudes comprised in one or more sub-bands of each of the frames.

10. The audio signal decoding method of claim 9, wherein the semantic information comprises at least one of spectral flatness, a spectral sub-band peak value, and a spectral flux value with respect to the one or more sub-bands.

11. An audio signal encoding apparatus comprising:
a transform unit which transforms an audio signal into a signal of a frequency domain;
a semantic information generation unit which extracts semantic information from the audio signal;
a sub-band reconfiguration unit which variably reconfigures one or more sub-bands comprised in the audio signal by segmenting or grouping the one or more sub-bands bands using the extracted semantic information; and
a first encoding unit which generates a quantized first bitstream by calculating a quantization step size and a scale factor with respect to a reconfigured sub-band of the one or more sub-bands.

12. The audio signal encoding apparatus of claim 11, the semantic information is defined in units of frames of the audio signal, and indicates a statistical value with respect to a plurality of coefficient amplitudes comprised in one or more sub-bands of each of the frames.

13. The audio signal encoding apparatus of claim 12, wherein the semantic information comprises an audio semantic descriptor that is metadata used in searching or categorizing music configured of the audio signal.

14. The audio signal encoding apparatus of claim 11, wherein the semantic information generation unit further comprises a flatness generation unit for which calculates spectral flatness of a first sub-band of the one or more sub-bands.

15. The audio signal encoding apparatus of claim 14, wherein:
the semantic information generation unit further comprises a sub-band peak value calculation unit which, if the spectral flatness is less than a predetermined threshold value, calculates a spectral sub-band peak value of the first sub-band; and
the sub-band reconfiguration unit comprises a segmenting unit which, if the spectral flatness is less than the predetermined threshold value, segments the first sub-band into a plurality of sub-bands according to the spectral sub-band peak value.

16. The audio signal encoding apparatus of claim 14, wherein:
the semantic information generation unit further comprises a flux value calculation unit which, if the spectral flatness is greater than a predetermined threshold value, calculates a spectrum flux value indicating variation of energy distributions between the first sub-band and a second sub-band adjacent to the first sub-band; and
the sub-band reconfiguration unit further comprises a grouping unit which, if the spectral flatness is greater than the predetermined threshold value and the spectrum flux value is less than a predetermined threshold value, groups the first sub-band and the second sub-band together.

17. The audio signal encoding apparatus of claim 15, further comprising a second encoding unit which generates a second bitstream comprising at least one of the spectral flatness and the spectral sub-band peak value,
wherein the second bitstream is transmitted together with the first bitstream.

18. An audio signal decoding apparatus comprising:
a receiving unit which receives a first bitstream of an encoded audio signal and a second bitstream indicating semantic information of the audio signal;
a sub-band determining unit which determines at least one sub-band of the audio signal that is variably configured in the first bitstream of the audio signal, by using the second bitstream indicating the semantic information; and
a decoding unit which calculates an inverse-quantization step size and a scale factor with respect to the at least one sub-band, and inverse quantizes the first bitstream based on the calculated inverse-quantization step size and the calculated scale factor.

19. The audio signal decoding apparatus of claim 18, wherein the semantic information is defined in units of frames of the encoded audio signal, and indicates a statistical value with respect to a plurality of coefficient amplitudes comprised in one or more sub-bands of each of the frames.

20. The audio signal decoding apparatus of claim 19, wherein the semantic information comprises at least one of spectral flatness, a spectral sub-band peak value, and a spectral flux value with respect to the one or more sub-bands.

21. The audio signal encoding method of claim 6, further comprising:
generating a second bitstream comprising at least one of the spectral flatness and the spectral flux value; and
transmitting the second bitstream with the first bitstream.

22. The audio signal encoding method of claim 5, wherein:
if the spectral flatness is greater than the predetermined threshold value, the extracting the semantic information further comprises calculating a spectrum flux value indicating variation of energy distributions between the first sub-band and a second sub-band adjacent to the first sub-band; and
if the spectral flatness is greater than the predetermined threshold value and the spectrum flux value is less than a predetermined threshold value, the variably reconfiguring the one or more sub-bands further comprises grouping the first sub-band and the second sub-band together.

23. The audio signal encoding method of claim 22, further comprising:
generating a second bitstream comprising at least one of the spectral flatness, the spectral sub-band peak value, and the spectral flux value; and
transmitting the second bitstream with the first bitstream.

24. The audio signal encoding apparatus of claim 16, further comprising a second encoding unit which generates a second bitstream comprising at least one of the spectral flatness and the spectral flux value,
wherein the second bitstream is transmitted together with the first bitstream.

25. An audio signal decoding method comprising:
determining at least one sub-band of an audio signal that is variably configured in a bitstream of the audio signal, by using semantic information of the audio signal transmitted with the audio signal; and
calculating an inverse-quantization step size and a scale factor with respect to the at least one sub-band, and inverse-quantizing the first bitstream based on the calculated inverse-quantization step size and the calculated scale factor.

26. A computer readable recording medium having recorded thereon a program executable by a computer for performing the method of claim 1.

27. A computer readable recording medium having recorded thereon a program executable by a computer for performing the method of claim 8.

28. A computer readable recording medium having recorded thereon a program executable by a computer for performing the method of claim 25.
